(19) United States
(12) Patent Application Publication
(10) Pub. No.: US 2011/0234140 A1
(43) Pub. Date: Sep. 29, 2011

(54) MOTOR DRIVE UNIT

(76) Inventor: Keisuke KURODA, Osaka (JP)

(21) Appl. No.: 12/939,011

(22) Filed: Nov. 3, 2010

(30) Foreign Application Priority Data
Mar. 29, 2010 (JP) 2010-075742

(51) Int. Cl. H02P 6/08

(52) U.S. Cl. 318/503

(57) ABSTRACT

The motor drive unit includes: an energized phase switch section; a power stage; a PWM control section; a torque comparison section configured to compare the voltage level of a torque command signal with the voltage level of a comparison reference signal; a comparison reference signal production section configured to produce the comparison reference signal; and an energization control section configured to drive the power stage by synchronous rectification PWM drive when the voltage level of the torque command signal is higher than the voltage level of the comparison reference signal, and by a scheme other than the synchronous rectification PWM drive when the voltage level of the torque command signal is lower than the voltage level of the comparison reference signal.

### CROSS-REFERENCE TO RELATED APPLICATION

This application claims priority to Japanese Patent Application No. 2010-75742 filed on Mar. 29, 2010, the disclosure of which including the specification, the drawings, and the claims is hereby incorporated by reference in its entirety.

### BACKGROUND

The present disclosure relates to a motor drive unit, and more particularly to synchronous rectification PWM drive of a brushless motor.

As one of methods for driving a brushless motor, a PWM drive scheme is known, in which energization of a drive coil is controlled by controlling on/off of a predetermined transistor connected to the drive coil. Moreover, in recent years, as a means for achieving low loss and high efficiency drive in the PWM drive scheme, a synchronous rectification PWM drive scheme has been widely known.

The synchronous rectification PWM drive scheme refers to a control in which, while a first transistor, out of two paired transistors connected to a drive coil, is PWM-switched off, the second transistor is turned on. Since a regenerative current is allowed to flow to the drive coil via the second transistor that is on, not via a diode connected in parallel with the second transistor, voltage drop occurring on this current path can be reduced. Thus, low loss and high efficiency drive can be achieved.

The present inventors have found the following two problems on the conventional synchronous rectification PWM drive.

The first problem is that a motor drive unit having no dedicated start/stop command terminal cannot execute free-run control.

The free-run control refers to a control of shutting off power supply to a drive coil and slowly reducing the inertia rotational speed of a motor to finally stop the motor. In some of motor-mounted equipment, sharp decrease of the inertia rotational speed is not allowed. In such a case, the free-run control of slowly reducing the speed is required.

Also, depending on the specifications of motor drive units, a torque command signal for determining the rotating torque of a motor is sometimes controlled directly or indirectly so that it can also be used as start/stop commands of the motor. Since start/stop of the motor can also be controlled with only the control of the torque command signal, this has an advantage that no dedicated start/stop command terminal is necessary. As a specific means, a start command is meant when the level of the torque command signal is increased to a level at which rotating torque is generated in the motor, and a stop command is meant when the level of the torque command signal is reduced to a level at which rotating torque is no more generated in the motor.

Referring to FIG. 13, the problem that a motor drive unit employing the synchronous rectification PWM drive and having no dedicated start/stop command terminal cannot execute free-run control will be described.

FIG. 13 is a view illustrating an example of the synchronous rectification PWM drive. Assume in this case that PWM drive signals are produced by slicing a torque command signal with a triangle wave. Also assume that the PWM drive signals for two paired transistors connected to a drive coil are both on when they are at a high level and off when they are at a low level, and that the motor rotating torque increases as the on-duty of the PWM drive signal for the first transistor is longer.

When the level of the torque command signal is higher than the lowest level of the triangle wave, the PWM drive signal is produced with a slicer, applying a high level to the first transistor. Therefore, motor rotating torque is generated, allowing a motor to rotate. Conversely, when the level of the torque command signal is lower than the lowest level of the triangle wave, the torque command signal cannot be sliced, and thus no high level is applied to the first transistor. Therefore, entering a zero torque state where no motor rotating torque is generated, the motor stops. In other words, the point at which the level of the torque command signal is equal to the lowest level of the triangle wave is a zero torque limit level.

In the zero torque state of the synchronous rectification PWM drive, the first transistor is off and the second transistor is on. When a plurality of drive coils and paired transistors in different phases are involved, also, the first transistors are off and the second transistors are on.

When the level of the torque command signal is lowered to below the zero torque limit level for stopping a rotating motor, the synchronous rectification PWM drive falls into the zero torque state. In this state, since all the first transistors are off and all the second transistors are on in the case of a plurality of phases, a brake current is generated in the drive coils due to an effect of a counter electromotive voltage of the motor. This results in brake control in which the inertia rotational speed of the motor is sharply reduced. In other words, the problem that free-run control cannot be executed occurs.

The second problem is that during pull-in to a preset rotational speed of the motor, the operation becomes unstable, increasing the pull-in time. This problem is significant, in particular, when the set rotational speed is low.

As an example of motor start control, a scheme is known in which the level of the torque command signal is set at a high torque level until the motor reaches a set rotational speed, for prompt rise of the motor rotational speed, and once the motor reaches the set rotational speed, the level of the torque command signal is reduced for pull-in to the set rotational speed.

Referring to FIG. 14, the problem that the operation becomes unstable during pull-in to a set rotational speed of the motor, increasing the pull-in time, in the synchronous rectification PWM drive will be described. FIG. 14 is a view illustrating an example of operation of pull-in to a set rotational speed of the motor. As in the case described with reference to FIG. 13, assume that PWM drive signals are produced by slicing a torque command signal with a triangle wave. Also assume that the motor rotating torque increases as the level of the torque command signal is higher.

It is assumed that, in the initial state, the level of the torque command signal is set to be below the lowest level of the triangle wave, and thus with no motor rotating torque being generated, the motor is at rest.

First, to start the motor, the level of the torque command signal is increased thereby to issue a start command. The torque command signal is set to the highest torque level exceeding the highest level of the triangle wave, allowing the motor rotating torque to rise to the highest torque level. The motor rotational speed gradually increases to finally reach the set rotational speed. A little response delay occurs until the arrival at the set rotational speed is detected and the level of the torque command signal is reduced. The motor rotational speed continues rising during this response delay, temporarily exceeding the set rotational speed. To reduce the exceeding motor rotational speed, a deceleration command is issued, and this reduces the level of the torque command signal. In particular, when the set rotational speed is low, the level of the torque command signal is temporarily reduced to as low as a zero torque level that is lower than the lowest level of the triangle wave.

Like the first problem described with reference to FIG. 13, when the zero torque state continues in the synchronous rectification PWM drive, a brake current is generated in the drive coils due to an effect of a counter electromotive voltage of the motor. At this time, the motor rotational speed sharply decreases. The decrease of the motor rotational speed to below the set rotational speed is detected, and, after a little response delay, an acceleration command is issued again for increase of the decreasing motor rotational speed. This increases the level of the torque command signal. After repetition of this series of operation, the motor finally completes pull-in to the set rotational speed.

During the above series of operation, there is a time at which a brake current is generated in the drive coils, resulting in sharp decrease of the motor rotational speed. At this time, the motor rotational speed once having risen to the set rotational speed significantly decreases. As a result, the control works to give a high torque again and sharply increase the motor rotational speed. In other words, since sharp decrease and increase of the motor rotational speed and the torque command signal are repeated, the operation becomes unstable, and thus the pull-in time becomes long.

### SUMMARY

According to the motor drive unit of a synchronous rectification PWM drive scheme disclosed herein, free-run control can be executed even when no dedicated start/stop command terminal is provided, and also operation is stable during pull-in to a set rotational speed of a motor, whereby the pull-in time can be shortened.

An illustrative motor drive unit includes: an energized phase switch section configured to switch an energized phase based on a rotor position of a motor; a power stage having a plurality of half bridges connected in parallel with each other, each of the half bridges including a high-side transistor and a low-side transistor connected in series between a power supply voltage and the ground and flywheel diodes respectively connected in parallel with the transistors; a PWM control section configured to produce a duty pulse signal having a duty ratio corresponding to a torque command signal; a torque comparison section configured to compare a voltage level of the torque command signal with a voltage level of a comparison reference signal; a comparison reference signal production section configured to produce the comparison reference signal; and an energization control section configured to PWM-drive the transistors of the power stage according to outputs of the energized phase switch section and the PWM control section, the energization control section, receiving an output of the torque comparison section, driving the power stage by synchronous rectification PWM drive in a first case where the voltage level of the torque command signal is higher than the voltage level of the comparison reference signal, and driving the power stage by a scheme other than the synchronous rectification PWM drive in a second case where the voltage level of the torque command signal is lower than the voltage level of the comparison reference signal.

Another illustrative motor drive unit includes: an energized phase switch section configured to switch an energized phase based on a rotor position of a motor; a power stage having a plurality of half bridges connected in parallel with each other, each of the half bridges including a high-side transistor and a low-side transistor connected in series between a power supply voltage and the ground and flywheel diodes respectively connected in parallel with the transistors; a PWM control section configured to produce a duty pulse signal having a duty ratio corresponding to a torque command signal; a duty detection section configured to detect whether or not the duty ratio of the duty pulse signal is larger than a predetermined value; an energization control section configured to PWM-drive the transistors of the power stage according to outputs of the energized phase switch section and the PWM control section, the energization control section, receiving an output of the duty detection section, driving the power stage by synchronous rectification PWM drive in a first case where the duty ratio of the duty pulse signal is larger than the predetermined value, and driving the power stage by a scheme other than the synchronous rectification PWM drive in a second case where the duty ratio of the duty pulse signal is smaller than the predetermined value.

With the above configurations, activation/deactivation of the synchronous rectification PWM drive can be switched according to the voltage level of the torque command signal or the duty ratio of the duty pulse signal. Therefore, free-run control can be executed even when no dedicated start/stop command terminal is provided. Also, operation is stable during pull-in to a set rotational speed of the motor, and thus the pull-in time can be shortened.

### BRIEF DESCRIPTION OF THE DRAWINGS

FIG. 1 is a block diagram of motor drive units of the first and second embodiments.

FIG. 2 is a specific circuit diagram of an energization control section of the motor drive units of the first and third embodiments.

FIG. 3 is an operational waveform chart of synchronous rectification PWM drive of the motor drive unit of the first embodiment.

FIG. 4 is an operational waveform chart of free-run control of the motor drive unit of the first embodiment.

FIG. 5 is an operational waveform chart of brake control of the motor drive unit of the first embodiment.

FIG. 6 is an operational waveform chart of pull-in to a set rotational speed of the motor drive unit of the first embodiment.

FIG. 7 is a specific circuit diagram of an energization control section of the motor drive units of the second and fourth embodiments.

FIG. 8 is an operational waveform chart of free-run control of the motor drive unit of the second embodiment.

FIG. 9 is a block diagram of the motor drive units of the third and fourth embodiments.

FIG. 10 is a specific circuit diagram of a duty detection section of the motor drive units of the third and fourth embodiments.

FIG. 11 is an operational waveform chart of free-run control of the motor drive unit of the third embodiment.

FIG. 12 is an operational waveform chart of free-run control of the motor drive unit of the fourth embodiment.

FIG. 13 is an operational waveform chart of synchronous rectification PWM drive of a conventional motor drive unit.

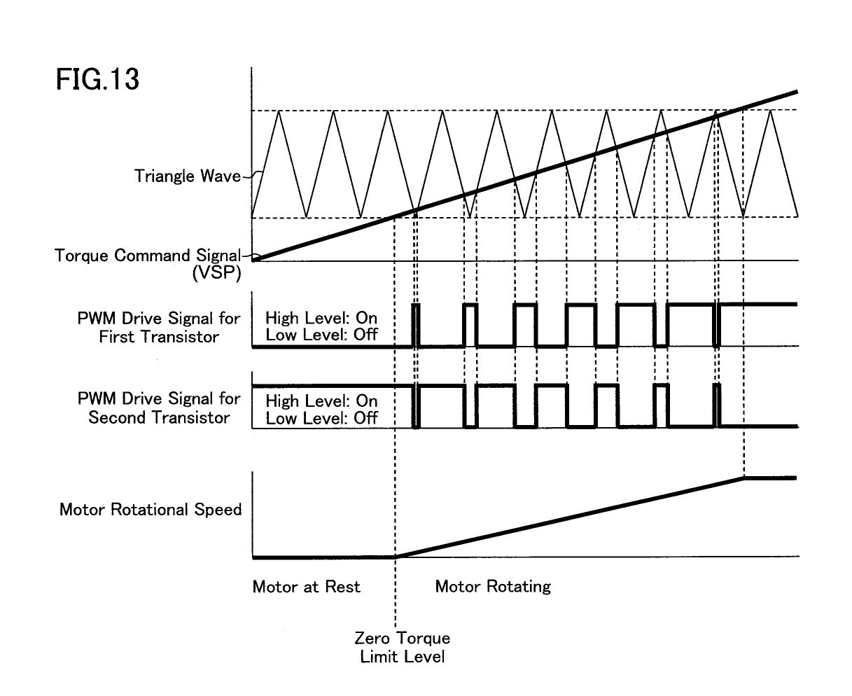

FIG. 14 is an operational waveform chart of pull-in to a set rotational speed of a conventional motor drive unit.

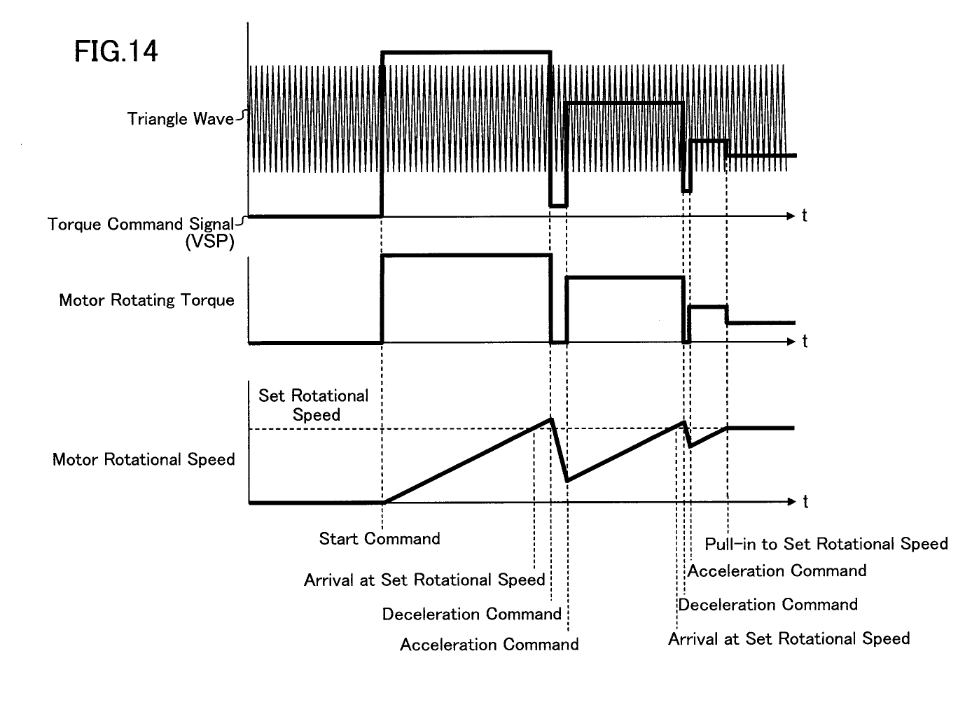

### DETAILED DESCRIPTION

Embodiments of the present invention will be described hereinafter with reference to the accompanying drawings. It should be noted that like components are denoted by the same reference characters, and repeated description of such components is omitted in some cases.

### First Embodiment

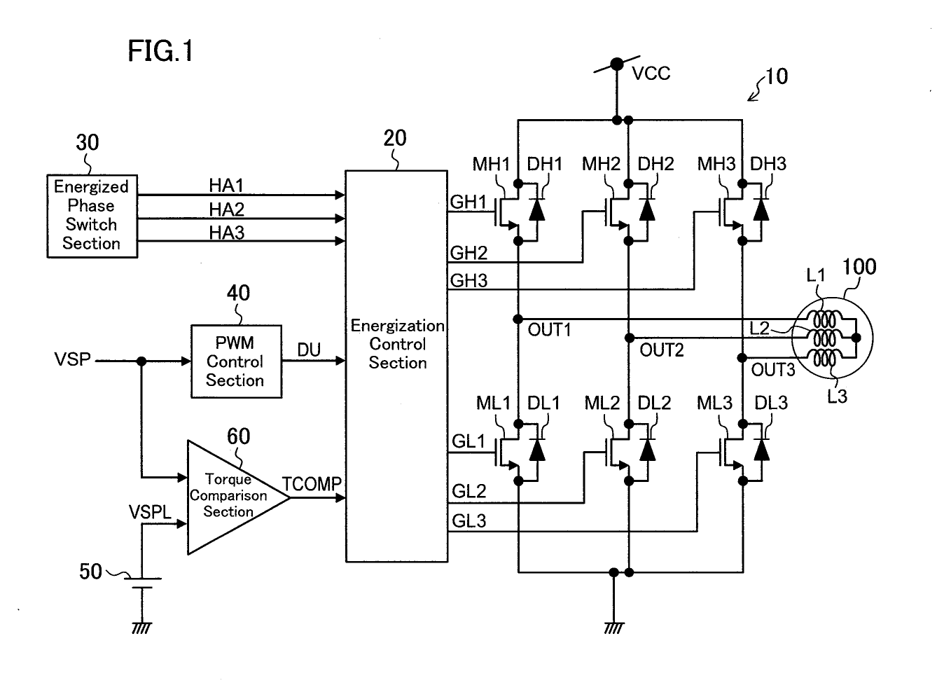

A motor drive unit of the first embodiment will be described. FIG. 1 is a block diagram showing an example of the entire configuration of the motor drive unit of the first embodiment. A motor as an object to be driven includes a rotor magnet 100 and drive coils Li (i is an integer from 1 to 3). The drive coils L1, L2, and L3 are commonly connected to each other at one end. A power stage 10 includes three parallel-connected half bridges each of which has a high-side transistor MiHi and a low-side transistor MLi connected in series between the power supply voltage VCC and the ground and flywheel diodes DHi and DLi respectively connected in parallel with the transistors MiHi and MLi. The other end of each drive coil Li is connected to a connection point OUTi between the high-side transistor MHi and the low-side transistor MLi.

The transistors MHi and MLi perform switching operation according to the logical level of drive signals GHi and GLi, respectively, output from an energization control section 20, to energize the drive coils Li, thereby generating drive electric power for driving the motor. The transistors MHi and MLi are respectively on when the logical levels of GHi and GLi are high, and off when they are low. As the transistors MHi and MLi, MOS transistors, bipolar transistors, IGBTs, etc. may be used. In this embodiment, n-channel MOS transistors are used.

An energized phase switch section 30 detects the positional relationship between the rotor magnet 100 and the drive coils Li, or the rotor positions in the motor, produces energized phase switch signals HAi as the detection results, and outputs the signals to the energization control section 20. For the detection of the rotor positions, a position detector such as a hall element, a sensorless means for monitoring a counter electromotive voltage of the drive coils Li, or the like can be used, although such an element is not shown. The signals HAi, corresponding to three-phase rotor positions, are displaced in angle by 120° from one another. The energization control section 20 switches the energized phase among the drive coils Li based on the signals HAi.

A torque command signal VSP is supplied for determining the rotating torque of the motor. The torque of the motor is set to be higher as the voltage level of VSP is higher, and lower as it is lower. The motor drive unit of this embodiment, having no dedicated start/stop command terminal, is directed to perform start/stop control by controlling the level of VSP. As a specific means, a start command is meant when VSP is increased to a level at which rotating torque is generated in the motor, and stop command is meant when VSP is reduced to a level at which rotating torque is no more generated in the motor. VSP may be configured so that the voltage level is directly applied and controlled, or otherwise the voltage level is indirectly controlled, like integrating a pulse signal for an acceleration command and a deceleration command into a capacitor (such a configuration is not shown).

A PWM control section 40 produces a duty pulse signal DU having a duty ratio corresponding to the VSP voltage level and outputs the signal to the energization control section 20. Assume that the on-duty of DU is set to be longer as the VSP voltage level is higher and shorter as it is lower. As a specific means, VSP is sliced with a triangle wave oscillating at an arbitrary frequency to produce DU. When the VSP voltage level is higher than the highest level of the triangle wave, DU is fixed to a high level, where the motor rotating torque is highest. Conversely, when the VSP voltage level is lower than the lowest level of the triangle wave, DU is fixed to a low level, where the motor rotating torque is zero. In other words, the limit level of the VSP voltage level at which zero torque is determined as the motor rotating torque is equivalent to the lowest level of the triangle wave.

A comparison reference signal production section 50 produces a comparison reference signal VSPL having an arbitrary voltage level and outputs the signal to a torque comparison section 60. The torque comparison section 60, which is a comparator, compares the voltage level of VSP with the voltage level of VSPL and outputs a torque detection signal TCOMP as the comparison result to the energization control section 20. Assume that TCOMP is high when the VSP voltage level is higher than the VSPL voltage level and low when the former is lower than the latter.

It is herein assumed that the voltage level of VSPL serving as the threshold is set to a level lower than the limit level of the VSP voltage level at which zero torque is determined as the motor rotating torque. That is, the VSPL voltage level is set to a level lower than the lowest level of the triangle wave.

The energization control section 20 outputs GHi and GLi for controlling on/off of the high-side transistors MHi and the low-side transistors MLi according to HAi, DU, and TCOMP. It is assumed that the energization control section 20 is adaptive to synchronous rectification PWM drive in which both the high-side transistors MHi and the low-side transistors MLi are PWM-operated, and activation/deactivation of the synchronous rectification PWM drive is selected according to TCOMP.

More specifically, when the VSP voltage level is higher than the VSPL voltage level, that is, when TCOMP is high, activation of the synchronous rectification PWM drive is selected. Conversely, when the VSP voltage level is lower than the VSPL voltage level, that is, when TCOMP is low, deactivation of the synchronous rectification PWM drive is selected.

In this embodiment, it is assumed that, when deactivation of the synchronous rectification PWM drive is selected, one-sided PWM drive is set where only either the high-side transistors MHi or the low-side transistors MLi are PWM-operated.

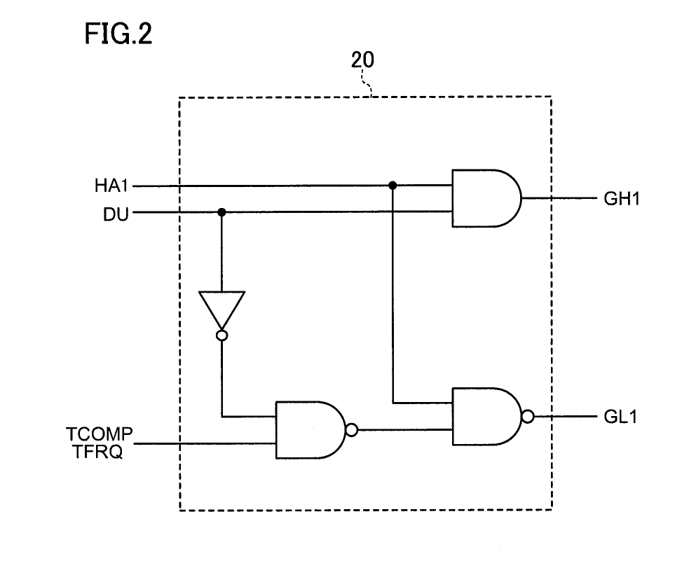

The energization control section 20 for controlling the above operations can be constructed of specific circuits as shown in FIG. 2, for example. Note that although FIG. 2 shows only a portion for producing GH1 and GL1 from HAL the other portions for producing GH2, GL2, GH3, and GL3 from HA2 and HA3 are similar in configuration to that of FIG. 2.

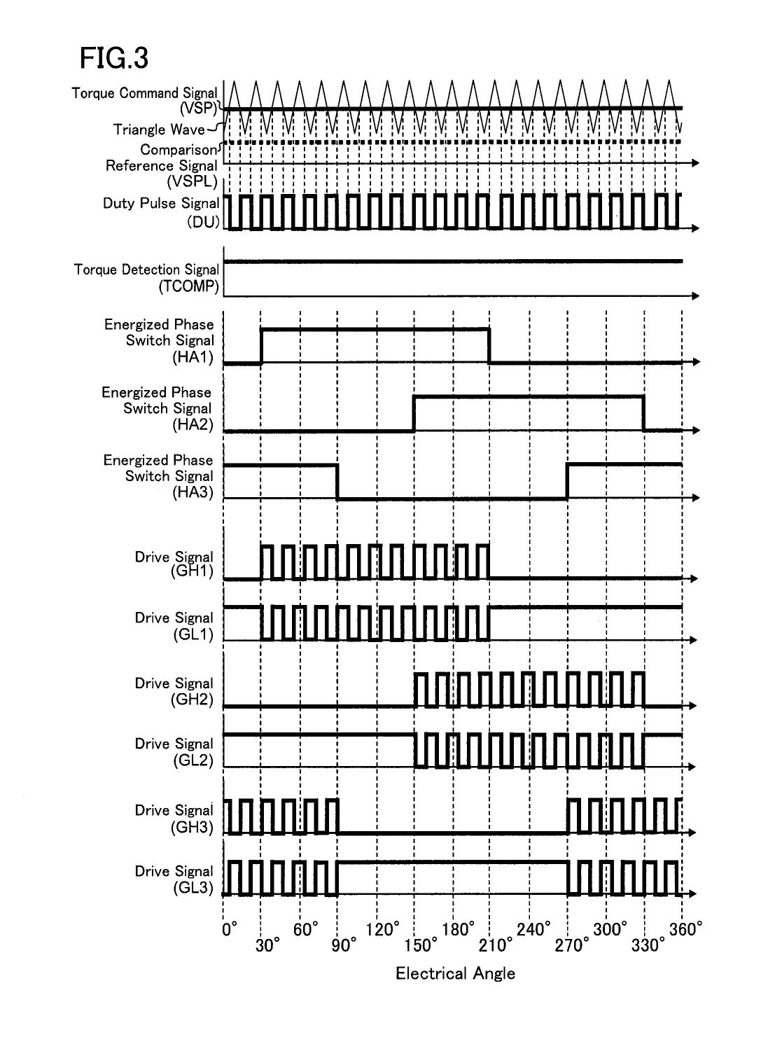

An example of operation of the synchronous rectification PWM drive of the motor drive unit of this embodiment will be described with reference to FIG. 3. In FIG. 3, with the VSP voltage level being higher than the VSPL voltage level, TCOMP is high indicating that the synchronous rectification PWM drive is being activated. Also, DU is being produced by slicing VSP with the triangle wave.

The x-axis of FIG. 3 represents the electrical angle, indicating operation over 360° or one period of the electrical angle. As described earlier, the signals HAi are displaced by 120° from one another. The transistors MHi and MLi are on when the logical levels of GHi and GLi are high, and off when they are low.

When HA1 is high, the signal corresponding to DU is output as GH1. Since the synchronous rectification PWM drive is being activated, GL1 goes low when GH1 is high, and conversely goes high when GH1 is low.

When HA1 is low, GH1 goes low, with no DU output as GH1, and GL1 goes high. As for the other phases, GH2 and GL2 corresponding to HA2, and GH3 and GL3 corresponding to HA3, operate similarly. The drive coils Li are energized by this series of operation, to generate electric power for driving the motor.

The drive scheme is not limited to the above, but three-phase modulated PWM drive and two-phase modulated PWM drive may be employed, in which segmented duty profiles are generated based on HAi and different duty pulse signals are allocated for GHi and GLi.

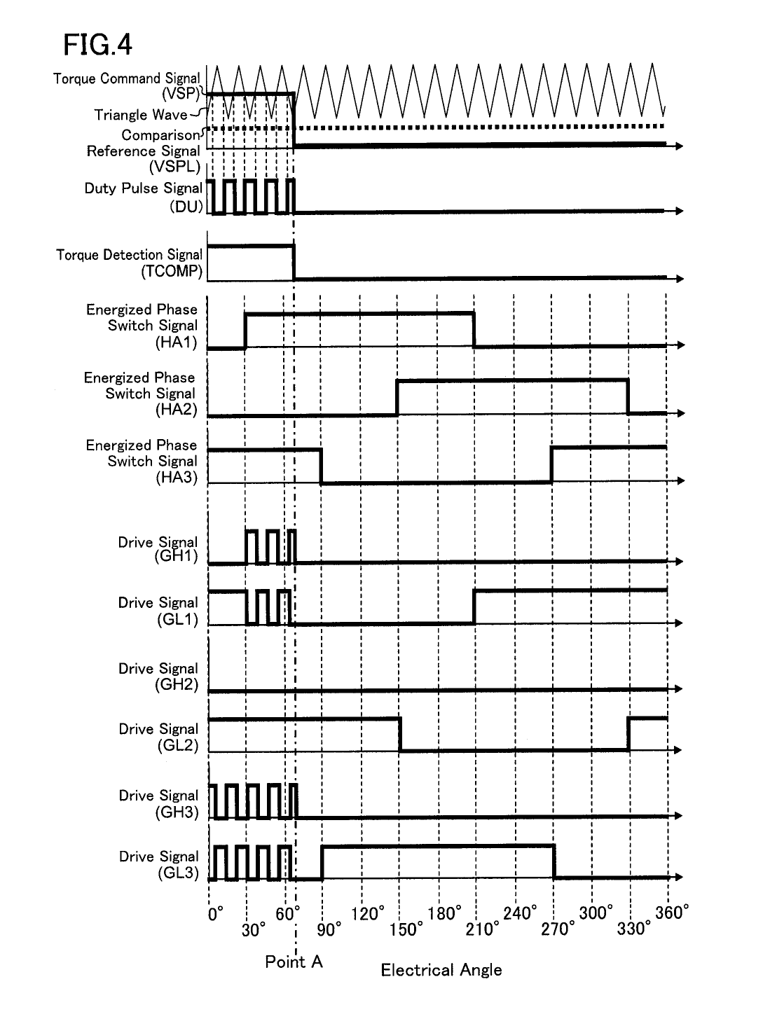

In the motor drive unit of this embodiment configured as described above, an example of operation in free-run control will be described with reference to FIG. 4. In FIG. 4, assume that the VSP voltage level is reduced to below the VSPL voltage level at an arbitrary time point (point A) in the operation shown in FIG. 3, to issue a stop command.

Once the VSP voltage level becomes lower than the lowest level of the triangle wave at point A, DU is fixed to the low level. Moreover, when the VSP voltage level becomes lower than the VSPL voltage level, TCOMP goes low.

Operation of GH1 and GL1 at and after point A will be described. When HA1 is high, the low-level signal corresponding to DU is output as GH1. Since TCOMP is low indicating that one-sided PWM drive is activated, GL1 remains low even though GH1 is low.

When HA1 is low, GH1 is low, with no DU output as GH1, and GL1 goes high. As for the other phases, GH2 and GL2 corresponding to HA2, and GH3 and GL3 corresponding to HA3, operate similarly.

To summarize the operation at and after point A, while the high-side transistors MHi are fixed to the off state, the low-side transistors MLi are on/off-controlled according to HAi: the low-side transistors MLi are on only when the rotating torque should be generated in the motor and off when a brake current is generated due to a counter electromotive voltage. As a result, without generation of a brake current that may otherwise sharply reduce the motor rotational speed, the free-run control allowing slow decrease of the inertia rotational speed of the motor can be executed.

After sufficient reduction of the inertia rotational speed of the motor, the one-sided PWM drive may be cancelled, and the synchronous rectification PWM drive may be activated again, or all-phase off control may be activated where all of the high-side transistors MHi and the low-side transistors MLi are turned off. In other words, the free-run control can be achieved with just activating the one-sided PWM drive for only a given span of time during the inertia rotation of the motor.

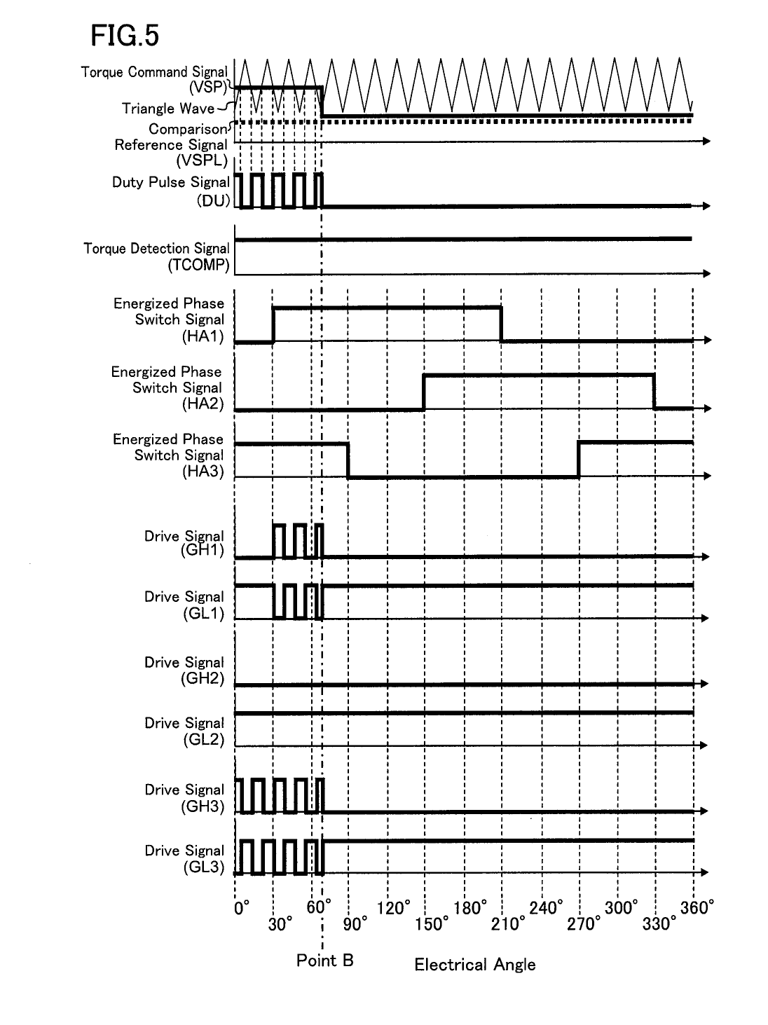

An example of operation in brake control will be described with reference to FIG. 5. In FIG. 5, assume that the VSP voltage level is set to be lower than the lowest level of the triangle wave and higher than the VSPL voltage level at an arbitrary time point (point B) in the operation shown in FIG. 3, to issue a stop command.

Once the VSP voltage level becomes lower than the lowest level of the triangle wave at point B, DU is fixed to the low level. TCOMP keeps the high level because the VSP voltage level is higher than the VSPL voltage level.

Operation of GH1 and GL1 at and after point B will be described. When HA1 is high, the low-level signal corresponding to DU is output as GH1. Since TCOMP is high indicating that the synchronous rectification PWM drive is being activated, GL1 goes high when GH1 is low.

When HA1 is low, GH1 remains low, with no DU output as GH1, and GL1 remains high. As for the other phases, GH2 and GL2 corresponding to HA2, and GH3 and GL3 corresponding to HA3, operate similarly.

To summarize the operation at and after point B, while the high-side transistors MHi are fixed to the off state, the low-side transistors MLi are fixed to the on state. Therefore, a brake current is generated due to a counter electromotive voltage of the motor. As a result, brake control allowing sharp decrease of the inertia rotational speed of the motor can be executed.

The details described above with reference to FIGS. 3, 4, and 5 can be summarized into three types of control as follows:

1. Motor rotation control by the synchronous rectification PWM drive is available when the VSP voltage level is set to be higher than the lowest level of the triangle wave.

2. Brake control is available when the VSP voltage level is lower than the lowest level of the triangle wave and higher than the VSPL voltage level.

3. Free-run control is available when the VSP voltage level is lower than the VSPL voltage level.

The three types of control described above are very effective for motor drive units similar to that of this embodiment, in which no dedicated start/stop command terminal is provided and start/stop is controlled by controlling the VSP voltage level. In other words, since the three states of motor rotation control, brake control, and free-run control can be controlled by only controlling VSP, this scheme has an advantage of having high versatility for various types of motor-mounted equipment having difference specifications.

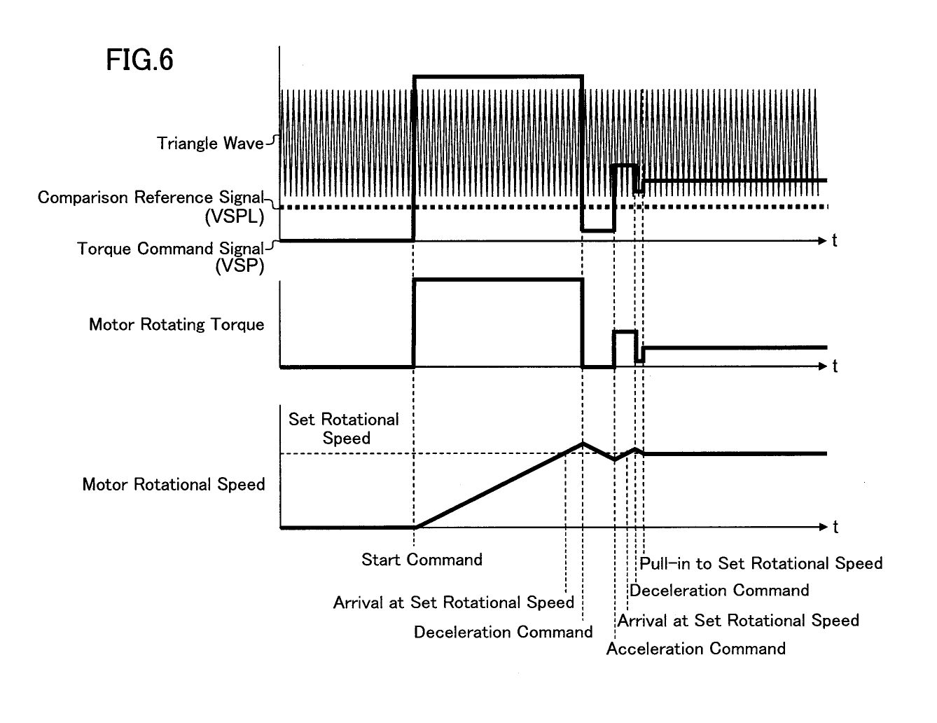

Next, referring to FIG. 6, an example of operation of pull-in to a set rotational speed of the motor will be described. In FIG. 6, the x-axis represents the time. Assume that, in the initial state, the VSP voltage level is set to be lower than the lowest level of the triangle wave, and thus with no motor rotating torque being generated, the motor is at rest.

First, to start the motor, the VSP voltage level is increased thereby to issue a start command. VSP is set to the highest torque level that is higher than the highest level of the triangle wave, to allow the motor rotating torque to rise to the highest torque level. This gradually increases the motor rotational speed to finally reach the set rotational speed. A little response delay occurs until the arrival at the set rotational speed is detected and the VSP voltage level is reduced. The motor rotational speed continues rising during this response delay, temporarily exceeding the set rotational speed. To reduce the exceeding motor rotational speed, a deceleration command is issued, and this reduces the VSP voltage level. When the set rotational speed is low, in particular, the VSP voltage level temporarily decreases to as low as a zero torque level that is lower than the lowest level of the triangle wave. Assume herein that the VSP voltage level has decreased to below the VSPL voltage level.

At this time, like the operation described above with reference to FIG. 4, the one-sided PWM drive is activated, causing no generation of a brake current that may otherwise sharply reduces the motor rotational speed. Therefore, the motor rotational speed slowly decreases. The decrease of the motor rotational speed to below the set rotational speed is detected, and, after a little response delay, an acceleration command is issued again to increase the decreasing motor rotational speed, and this increases the level of the torque command signal. After repetition of this series of operation, the motor finally completes pull-in to the set rotational speed.

During the above series of operation, the time when a brake current may be generated in the drive coils causing sharp decrease of the motor rotational speed is limited to the range of time in which the VSP voltage level is lower than the lowest level of the triangle wave and higher than the VSPL voltage level. By previously setting the lowest level of the triangle wave and the VSPL voltage level at values very close to each other, this range of time can be shortened, and thus generation of a brake current can be minimized.

Since occurrence of brake control, which may significantly reduce the motor rotational speed that has once increased up to the set rotational speed, can be minimized, fluctuation of the motor rotational speed is slow. As a result, sharp fluctuation of the motor rotating torque can be suppressed. In other words, since sharp decrease and increase of the motor rotational speed and VSP can be suppressed, stable operation is ensured, and thus the time required to complete pull-in to the set rotational speed can be shortened.

Next, the reason why the VSPL voltage level as the threshold should be set to be lower than the lowest level of the triangle wave will be described.

When rotating torque is generated in the motor, which is considered as having an intention to rotate the motor, the synchronous rectification PWM drive is made available at any time, to achieve low loss and high efficiency drive. When no rotating torque is generated in the motor, which is considered as having an intention to decelerate or stop the motor, the synchronous rectification PWM drive is deactivated, to execute the free-run control of slowly reducing the rotational speed. In other words, by detecting the rotating torque of the motor, appropriate control according to the situation can be achieved.

As described above, in this embodiment, the following advantages can be obtained. By having the control of detecting the VSP voltage level to switch the drive to the one-sided PWM drive, the motor drive unit employing the synchronous rectification PWM drive can execute the free-run control even though being provided with no dedicated start/stop command terminal, and also can operate stably during the pull-in to the set rotational speed of the motor, whereby the pull-in time can be shortened.

### Second Embodiment

A motor drive unit of the second embodiment will be described as follows. Note that the entire configuration of the motor drive unit of this embodiment is similar to that of the motor drive unit of the first embodiment, and thus description of similar portions is omitted here. This embodiment is different from the first embodiment in the internal configuration of the energization control section 20.

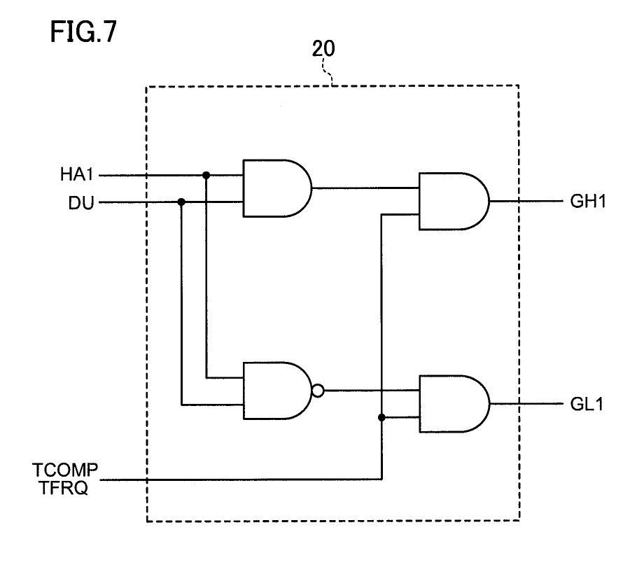

In the energization control section 20 of the motor drive unit of this embodiment, it is assumed that, when deactivation of the synchronous rectification PWM drive is selected, all-phase off control is activated where all of the high-side transistors MHi and the low-side transistors MLi are turned off. The energization control section 20 for controlling this operation may be constructed of specific circuits as shown in FIG. 7, for example. Note that although FIG. 7 shows only a portion for producing GH1 and GL1 from HAL the other portions for producing GH2, GL2, GH3, and GL3 from HA2 and HA3 are similar in configuration to that of FIG. 7.

When activation of the synchronous rectification PWM drive is being selected, the operation is similar to that described with reference to FIG. 3, and thus description thereof is omitted here.

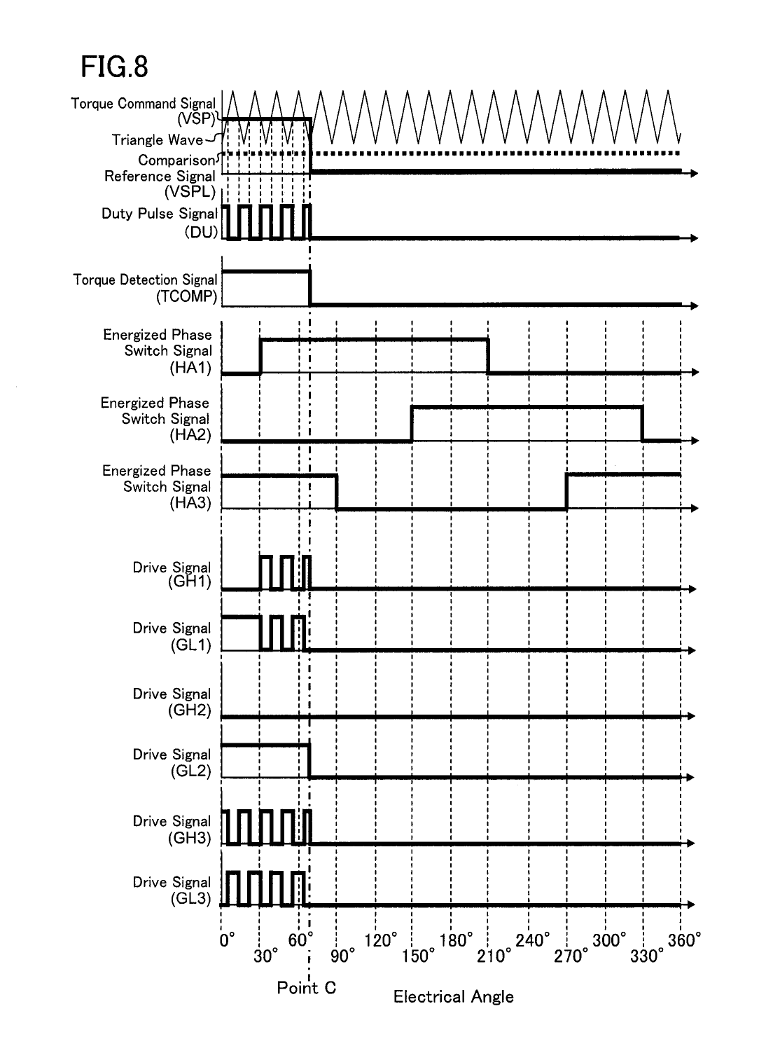

In the motor drive unit of this embodiment configured as described above, an example of operation in free-run control will be described with reference to FIG. 8. In FIG. 8, assume that the VSP voltage level is reduced to below the VSPL voltage level at an arbitrary time point (point C) in the operation shown in FIG. 3, to issue a stop command.

Once the VSP voltage level becomes lower than the lowest level of the triangle wave at point C, DU is fixed to the low level. Moreover, when the VSP voltage level becomes lower than the VSPL voltage level, TCOMP goes low.

Operation of GHi and GLi at and after point C will be described. Since TCOMP is low indicating that the all-phase off control is activated, all of GHi and GLi go low, turning off all the high-side transistors MHi and the low-side transistors MLi. As a result, without generation of a brake current that may otherwise sharply reduce the motor rotational speed, the free-run control permitting slow decrease of the inertia rotational speed of the motor can be executed.

After sufficient reduction of the inertia rotational speed of the motor, the all-phase off control may be cancelled, and the synchronous rectification PWM drive may be activated again, or one-sided PWM drive may be activated. In other words, the free-run control can be achieved with just activating the all-phase off control for only a given span of time during the inertia rotation of the motor.

In the motor drive unit of this embodiment, when deactivation of the synchronous rectification PWM drive is selected, all the high-side transistors MHi and the low-side transistors MLi are turned off, shutting off the entire power supply to the drive coils Li. Thus, more stable free-run control can be executed.

The motor drive unit of this embodiment is different from that of the first embodiment only in that all-phase off control is employed when deactivation of the synchronous rectification PWM drive is selected. Whether the one-sided PWM drive or the all-phase off control is employed, a similar advantage can be obtained in the aspect of slowly reducing the inertia rotational speed of the motor. Therefore, the other advantages described above in the first embodiment can also be obtained in this embodiment.

As described above, in this embodiment, the following advantages can be obtained. By having the control of detecting the VSP voltage level to switch the drive to the all-phase off control, the motor drive unit employing the synchronous rectification PWM drive can execute the free-run control even though being provided with no dedicated start/stop command terminal, and also can operate stably during the pull-in to the set rotational speed of the motor, whereby the pull-in time can be shortened.

### Third Embodiment

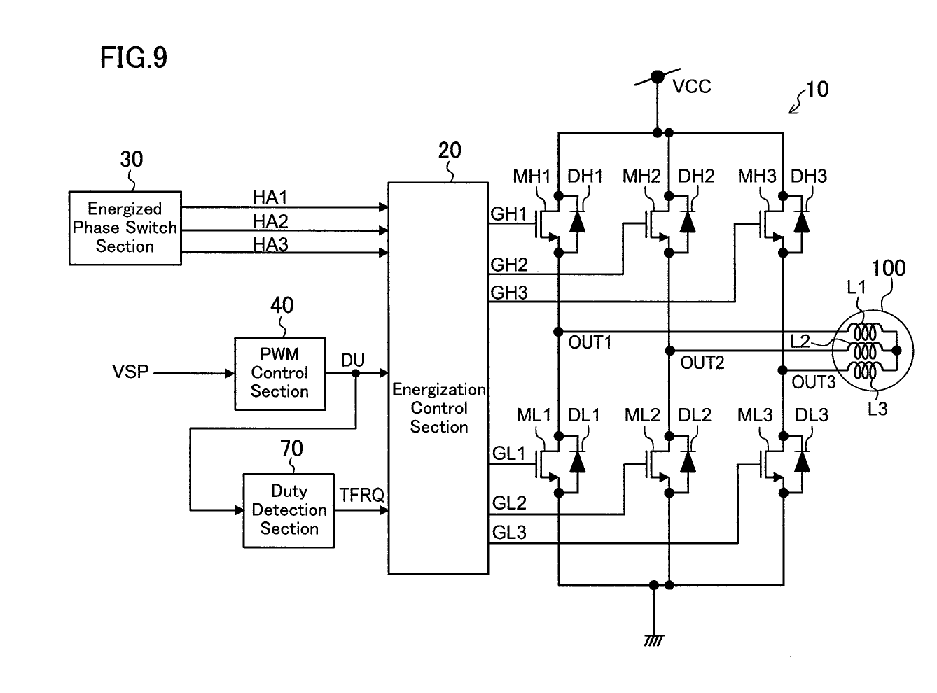

A motor drive unit of the third embodiment will be described. FIG. 9 is a block diagram showing an example of the entire configuration of the motor drive unit of the third embodiment. The motor drive unit of this embodiment is different from the motor drive units of the first and second embodiments in that a duty detection section 70 is provided in place of the comparison reference signal production section 50 and the torque comparison section 60 in the first and second embodiments. Description of the other portions already described is omitted here.

The duty detection section 70 detects whether or not the duty ratio of DU is larger than a predetermined value, and outputs a duty detection signal TFRQ as the detected result to the energization control section 20. Assume that TFRQ is high when the duty ratio of DU is larger than the predetermined value, and is low when it is smaller than the predetermined value. The predetermined value is assumed herein to be the duty ratio of DU observed when the VSP voltage level is set to a level lower than the limit level at which zero torque is determined as the motor rotating torque. That is, TFRQ goes high when DU becomes high even for a short time, and goes low when DU does not become high at all.

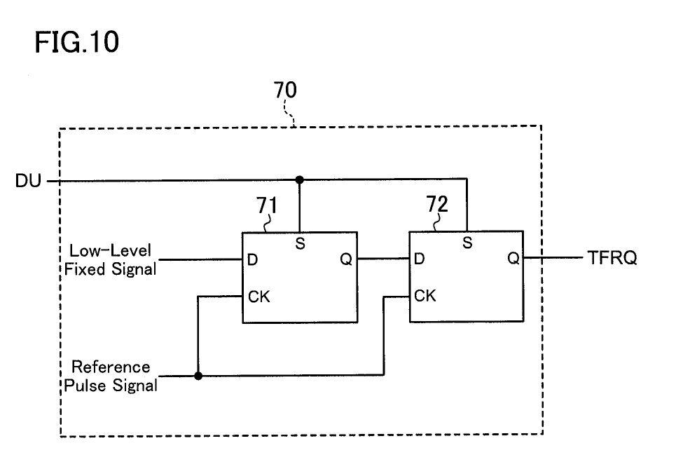

The duty detection section 70 for controlling the above operation can be constructed of specific circuits as shown in FIG. 10, for example. Each of flipflops 71 and 72 has a set terminal S, a signal input terminal D, a clock input terminal CK, and an output terminal Q. The flipflops operate as follows. When a high level is input at the set terminal S, the output terminal Q is fixed to a high level. When a low level is input at the set terminal S, a signal at the input terminal D is passed to the output terminal Q at timing of input of a rising edge at the clock input terminal CK. The signal at the input terminal D is held when no rising edge is input at the clock input terminal CK. A low-level fixed signal is input at the signal input terminal D of the flipflop 71, and the output of the flipflop 71 is input at the signal input terminal D of the flipflop 72. A reference pulse signal oscillating at an arbitrary period is input at the clock input terminals CK of the flipflops 71 and 72. The oscillation period of the reference pulse signal is assumed to be the same as the oscillation period of the triangle wave.

The operation of the duty detection section 70 will be described. At the time point when DU goes high, TFRQ goes high. After DU goes low, TFRQ will go low if the rising edge of the reference pulse signal is input twice before DU goes high again. The oscillation period of the reference pulse signal is the same as that of the triangle wave. Therefore, to allow TFRQ to go low, an operation of keeping DU from becoming high over one period of the triangle wave is necessary. The duty detection section 70 operating as described above detects the state of DU becoming high or not and outputs TFRQ.

Note that when a scheme, such as three-phase modulated PWM drive and two-phase modulated PWM drive, in which segmented duty profiles are generated based on HAi and different duty pulse signals are allocated for GHi and GLi is employed, DU in one arbitrary state among the duty profiles may be selected, to detect the level of the selected one.

The energization control section 20 of the motor drive unit of this embodiment is different from that in the first and second embodiments only in that TFRQ replaces TCOMP. The configuration is therefore the same as that shown in FIG. 2 as an example of specific circuits except that TFRQ replaces TCOMP. Description of the other portions already described is omitted here.

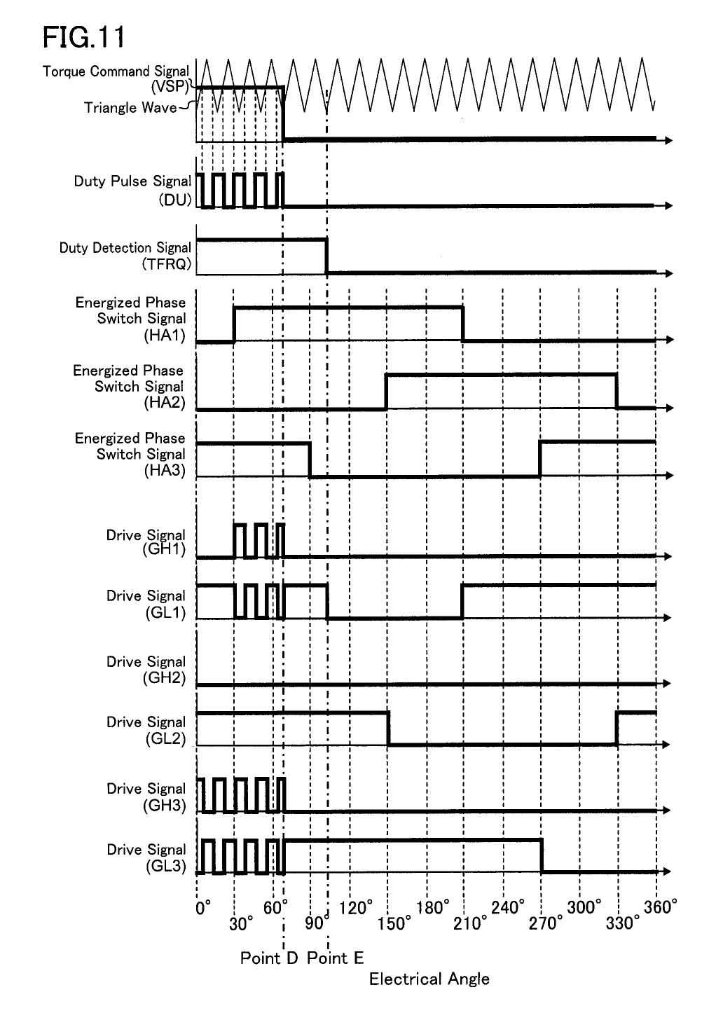

In the motor drive unit of this embodiment configured as described above, an example of operation in free-run control will be described with reference to FIG. 11. In FIG. 11, as in FIG. 4, assume that the VSP voltage level is reduced to below the lowest level of the triangle wave at an arbitrary time point (point D), to issue a stop command.

Once the VSP voltage level becomes lower than the lowest level of the triangle wave at point D, DU is fixed to the low level. At and after point D, when the rising edge of the reference pulse signal is input twice, TFRQ goes low with the operation of the duty detection section 70. Since the oscillation period of the reference pulse signal is the same as that of the triangle wave, TFRQ goes low at point E delayed from point D by two periods of the triangle wave.

Operation of GH3 and GL3 between point D and point E will be described. When HA3 is high, the low-level signal corresponding to DU is output as GH3. Since TFRQ is high indicating that the synchronous rectification PWM drive is being activated, GL3 goes high.

When HA3 is low, no DU is output as GH3. GH3 remains low, and GL3 remains high. As for the other phases, GH2 and GL2 corresponding to HA2, and GH1 and GL1 corresponding to HAL operate similarly.

To summarize the operation between point D and point E, while the high-side transistors MHi are fixed to the off state, the low-side transistors MLi are fixed to the on state. At and after point E, with TFRQ going low, one-sided PWM drive is activated. The operation at and after point E is similar to that at and after point A in FIG. 4, and thus description is omitted.

During the series of operation described above, the time when a brake current may be generated in the drive coils causing reduction of the motor rotational speed is limited to the range of time between point D and point E during which the high-side transistors MHi are fixed to the off state and the low-side transistors MLi are fixed to the on state. The time between point D and point E depends on the frequency of the triangle wave. Since the PWM frequency (triangle wave frequency) of general motor drive units is several tens of kHz, which is comparatively high, the time between D and E is very short. Therefore, the sharp decrease of the motor rotational speed due to occurrence of brake control can be suppressed to a substantially non-affecting level. As a result, with suppression of generation of a brake current that may otherwise sharply reduce the motor rotational speed to a substantially non-affecting level, the free-run control allowing slow decrease of the inertia rotational speed of the motor can be executed.

After sufficient reduction of the inertia rotational speed of the motor, the one-sided PWM drive may be cancelled, and the synchronous rectification PWM drive may be activated again, or all-phase off control may be activated. In other words, the free-run control can be achieved with just activating the one-sided PWM drive for only a given span of time during the inertia rotation of the motor.

The operation of pull-in to the set rotational speed of the motor is similar to that described above with reference to FIG. 6, and similar advantages can be obtained. Description of this operation is therefore omitted here.

Next, the reason why TFRQ is set to the high level when DU becomes high even for a short time and set to the low level when DU does not become high at all will be described.

As in the first embodiment, when rotating torque is generated in the motor, which is considered as having an intention to rotate the motor, the synchronous rectification PWM drive is made available at any time, to achieve low loss and high efficient drive. When no rotating torque is generated in the motor, which is considered as having an intention to decelerate or stop the motor, the synchronous rectification PWM drive is deactivated, to execute the free-run control of slowly reducing the rotational speed. In other words, by detecting the rotating torque of the motor, appropriate control according to the situation can be achieved.

As described above, in this embodiment, the following advantages can be obtained. By having the control of detecting the duty ratio of DU to switch the drive to the one-sided PWM drive, the motor drive unit employing the synchronous rectification PWM drive can execute the free-run control even though being provided with no dedicated start/stop command terminal, and also can operate stably during pull-in to the set rotational speed of the motor, whereby the pull-in time can be shortened.

### Fourth Embodiment

A motor drive unit of the fourth embodiment will be described as follows. Note that the entire configuration of the motor drive unit of this embodiment is similar to that of the motor drive unit of the third embodiment, and thus description of similar portions is omitted here. This embodiment is different from the third embodiment in the internal configuration of the energization control section 20.

In the energization control section 20 of the motor drive unit of this embodiment, it is assumed that, when deactivation of the synchronous rectification PWM drive is selected, all-phase off control is activated. The configuration of the energization control section 20 is the same as that shown in FIG. 7 as an example of specific circuits except that TFRQ replaces TCOMP. Description of the other portions already described is omitted here.

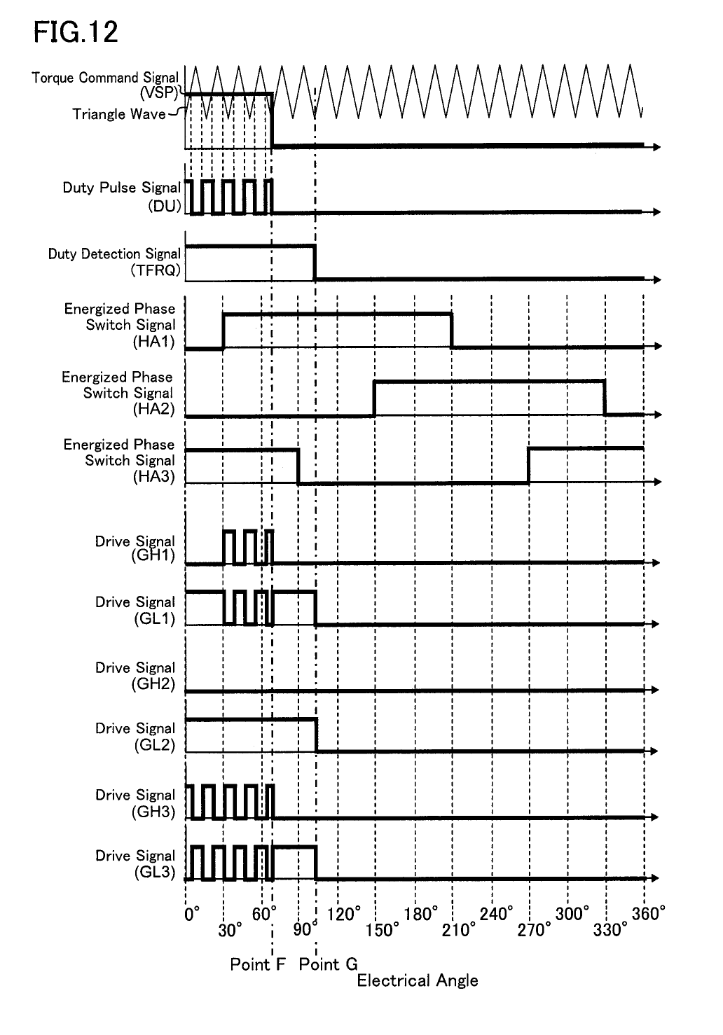

In the motor drive unit of this embodiment configured as described above, operation in free-run control will be described with reference to FIG. 12. In FIG. 12, as in FIG. 11, assume that the VSP voltage level is reduced to below the lowest level of the triangle wave at an arbitrary time point (point F), to issue a stop command.

The operation until point G is similar to that until point E in FIG. 11, and thus description is omitted here. At and after point G, with TFRQ going low, all-phase off control is activated. The operation at and after point G is similar to that at and after point C in FIG. 8, and thus description is omitted. As a result, with suppression of generation of a brake current that may otherwise sharply reduce the motor rotational speed to a substantially non-affecting level, the free-run control allowing slow decrease of the inertia rotational speed of the motor can be executed.

After sufficient reduction of the inertia rotational speed of the motor, the all-phase off control may be cancelled, and the synchronous rectification PWM drive may be activated again, or one-sided PWM drive may be activated. In other words, the free-run control can be achieved with just activating the all-phase off control for only a given span of time during the inertia rotation of the motor.

In the motor drive unit of this embodiment, when deactivation of the synchronous rectification PWM drive is selected, all the high-side transistors MHi and the low-side transistors MLi are turned off, shutting off the entire power supply to the drive coils Li. Thus, more stable free-run control can be executed.

The motor drive unit of this embodiment is different from that of the third embodiment only in that the all-phase off control is employed when deactivation of the synchronous rectification PWM drive is selected. Whether the one-sided PWM drive or the all-phase off control is employed, a similar advantage can be obtained in the aspect of slowly reducing the inertia rotational speed of the motor. Therefore, the other advantages described above in the third embodiment can also be obtained in this embodiment.

As described above, in this embodiment, the following advantages can be obtained. By having the control of detecting the duty ratio of DU to switch the drive to the all-phase off control, the motor drive unit employing the synchronous rectification PWM drive can execute free-run control even though being provided with no dedicated start/stop command terminal, and also can operate stably during pull-in to the set rotational speed of the motor, whereby the pull-in time can be shortened.

The present invention is not limited to the embodiments described above, but various modifications are possible. It is to be understood that such modifications are also included within the scope of the present invention.

What is claimed is:

1. A motor drive unit, comprising:
an energized phase switch section configured to switch an energized phase based on a rotor position of a motor;
a power stage having a plurality of half bridges connected in parallel with each other, each of the half bridges including a high-side transistor and a low-side transistor connected in series between a power supply voltage and the ground and flywheel diodes respectively connected in parallel with the transistors;
a PWM control section configured to produce a duty pulse signal having a duty ratio corresponding to a torque command signal;
a torque comparison section configured to compare a voltage level of the torque command signal with a voltage level of a comparison reference signal;
a comparison reference signal production section configured to produce the comparison reference signal; and
an energization control section configured to PWM-drive the transistors of the power stage according to outputs of the energized phase switch section and the PWM control section, the energization control section, receiving an output of the torque comparison section, driving the power stage by synchronous rectification PWM drive in a first case where the voltage level of the torque command signal is higher than the voltage level of the comparison reference signal, and driving the power stage by a scheme other than the synchronous rectification PWM drive in a second case where the voltage level of the torque command signal is lower than the voltage level of the comparison reference signal.

2. The motor drive unit of claim 1, wherein
start/stop of the motor is controlled according to the level of the torque command signal.

3. The motor drive unit of claim 1, wherein
the voltage level of the comparison reference signal is a level at which no rotating torque is generated in the motor.

4. The motor drive unit of claim 3, wherein
the PWM control section produces the duty pulse signal by slicing the torque command signal with a triangle wave, and
the voltage level of the comparison reference signal is lower than a lowest level of the triangle wave.

5. The motor drive unit of claim 1, wherein
the energization control section executes one-sided PWM drive of PWM-driving only either the high-side transistors or the low-side transistors of the power stage in the second case.

6. The motor drive unit of claim 1, wherein
the energization control section executes all-phase off control of turning off all the high-side transistors and the low-side transistors of the power stage in the second case.

7. A motor drive unit, comprising:
an energized phase switch section configured to switch an energized phase based on a rotor position of a motor;
a power stage having a plurality of half bridges connected in parallel with each other, each of the half bridges including a high-side transistor and a low-side transistor connected in series between a power supply voltage and the ground and flywheel diodes respectively connected in parallel with the transistors;
a PWM control section configured to produce a duty pulse signal having a duty ratio corresponding to a torque command signal;
a duty detection section configured to detect whether or not the duty ratio of the duty pulse signal is larger than a predetermined value;
an energization control section configured to PWM-drive the transistors of the power stage according to outputs of the energized phase switch section and the PWM control section, the energization control section, receiving an output of the duty detection section, driving the power stage by synchronous rectification PWM drive in a first case where the duty ratio of the duty pulse signal is larger than the predetermined value, and driving the power stage by a scheme other than the synchronous rectification PWM drive in a second case where the duty ratio of the duty pulse signal is smaller than the predetermined value.

8. The motor drive unit of claim 7, wherein
start/stop of the motor is controlled according to the level of the torque command signal.

9. The motor drive unit of claim 7, wherein
the predetermined value is a value with which no rotating torque is generated in the motor.

10. The motor drive unit of claim 7, wherein
the energization control section executes one-sided PWM drive of PWM-driving only either the high-side transistors or the low-side transistors of the power stage in the second case.

11. The motor drive unit of claim 7, wherein
the energization control section executes all-phase off control of turning off all the high-side transistors and the low-side transistors of the power stage in the second case.
